(19) United States
(12) Patent Application Publication
(10) Pub. No.: US 2026/0316615 A1
(43) Pub. Date: Oct. 15, 2026

(54) ELECTRIC AUXILIARY POWER DISTRIBUTION SYSTEM FOR A HYBRID ELECTRIC VEHICLE, AND METHOD OF CHARGING A BATTERY FOR A HYBRID ELECTRIC VEHICLE

(71) Applicant: CUMMINS INC., Columbus, IN (US)

(72) Inventors: Timothy C. Ernst, Columbus, IN (US); Aaron William Beinborn, Greenwood, IN (US); Jeremy David Walker, Columbus, IN (US); Veronica Pirie, Columbus, IN (US); James A. Zigan, Versailles, IN (US); Arun Prakash Thunga Gopal, Columbus, IN (US); Manik Narula, Columbus, IN (US); Hamza Anwar, Columbus, IN (US); Vishavjit Singh, Sacramento, CA (US); Aditi Rana, Columbus, IN (US); Carlos Alcides Lana, Columbus, IN (US); J. Steven Kolhouse, Columbus, IN (US); Kenneth M. Follen, Greenwood, IN (US); Frank Husmeier, Columbus, IN (US); Jairo Andres Sandoval Leon, Columbus, IN (US)

(73) Assignee: CUMMINS INC., Columbus, IN (US)

(21) Appl. No.: 19/644,866

(22) Filed: Apr. 10, 2026

Related U.S. Application Data
(60) Provisional application No. 63/787,505, filed on Apr. 11, 2025.

(51) Int. Cl. B60L 53/62; B60L 7/12; B60L 50/62; B60L 53/57; B60L 53/68; B60L 58/12; B60R 16/033

(52) U.S. Cl. CPC B60L 53/62; B60L 7/12; B60L 50/62; B60L 53/57; B60L 53/68; B60L 58/12; B60R 16/033; B60L 2210/10; B60L 2240/62; B60L 2240/72; B60L 2240/80; B60L 2260/22; B60L 2260/46; B60L 2260/54

(57) ABSTRACT

An electric auxiliary power distribution system for a hybrid electric vehicle including a battery pack, a power system, a charge determination module, and a controller. The power system is configured to supply power to the battery pack from an engine. The controller is communicably coupled to the power system and the charge determination module. The controller is configured to: receive, from the charge determination module, a charge parameter associated with a hoteling event of the hybrid electric vehicle; determine a threshold state of charge based on the charge parameter; and control the power system to increase a state of charge of the battery pack to satisfy the threshold state of charge.

### CROSS-REFERENCE TO RELATED APPLICATIONS

This application claims the benefit of, and priority to, U.S. Provisional Patent Application No. 63/787,505, filed Apr. 11, 2025, the entire contents of which are incorporated by reference herein.

### TECHNICAL FIELD

The present disclosure relates to hybrid electric sleeper cab vehicles and climate control systems for hybrid electric sleeper cab vehicles.

### BACKGROUND

Sleeper cab vehicles, which may also be referred to as sleeper vehicles, include on-highway vehicles having a compartment designed for drivers to rest and sleep during long-haul trips. Such sleeper cab vehicles may include a climate control system to maintain a comfortable environment within the compartment during hoteling, or periods of non-operation when the engine of the sleeper cab vehicle is shut off and the driver is sleeping or otherwise positioned within the compartment.

### SUMMARY

One embodiment of the present disclosure relates to an electric auxiliary power distribution system for a hybrid electric vehicle. The electric auxiliary power distribution system includes a battery pack, a power system, a charge determination module, and a controller. The power system is configured to supply power to the battery pack from an engine. The controller is communicably coupled to the power system and the charge determination module. The controller is configured to: receive, from the charge determination module, a charge parameter; determine a threshold state of charge based on the charge parameter; and control the power system to increase a state of charge of the battery pack to satisfy the threshold state of charge.

In some embodiments the charge determination module includes a user interface configured to receive a user input indicative of a desired operating duration of a climate control system of the hybrid electric vehicle during hoteling, and the controller configured to determine the threshold state of charge based on the user input.

In some embodiments, the electric auxiliary power distribution system further includes a location sensor configured to generate location data indicative of a geographic location of the hybrid electric vehicle. In such embodiments, the controller may be further configured to: determine, based on the location data, a charge duration; and control the power system to increase a state of charge of the battery pack to satisfy the threshold state of charge within the charge duration.

In some embodiments, the electric auxiliary power distribution system further includes a battery sensor coupled to the battery pack, where the battery sensor is configured to generate charge data indicative of the state of charge of the battery pack, and where the controller is further configured to: determine a charge rate based on the state of charge, the charge duration, and the threshold state of charge; and control the power system to supply electrical energy to the battery pack according to the charge rate.

In some embodiments, the controller is further configured to: determine, based on the location data, a distance between the hybrid electric vehicle and a hoteling location; and determine the charge duration based on the distance.

In some embodiments, the charge determination module includes a telematics module configured to communicably couple the controller to a fleet management service.

Another embodiment relates to a hybrid electric vehicle including: an engine system; a cab coupled to the engine system; a climate control system coupled to the cab; and the electric auxiliary power distribution system, where the charge parameter is indicative of an operating duration of the climate control system.

In some embodiments, the hybrid electric vehicle further includes: a DC-to-DC converter coupled between the climate control system and the battery pack; and a second battery coupled between the DC-to-DC converter and the engine system.

In some embodiments, the charge parameter includes a hoteling condition that varies with duration of a hoteling event, and the controller is configured to determine the threshold state of charge by at least one of averaging or integrating the hoteling condition over the duration.

In some embodiments, the charge parameter includes a hoteling condition and a duration of the hoteling event, and the controller is configured to determine the threshold state of charge by determining an energy usage associated with the hoteling condition and the duration.

In some embodiments, the charge parameter includes at least one of a time period for hoteling, a location of hoteling, an environmental condition within a cab of the hybrid electric vehicle during hoteling, a weather condition, or a route condition.

In some embodiments, the charge parameter includes at least one parameter indicative of an anticipated energy demand associated with the hoteling event and/or a post-hoteling vehicle operation.

In some embodiments, the controller is configured to determine the threshold state of charge based on a combination of a hoteling condition that occurs during the hoteling event; and a post-hoteling vehicle operating condition that occurs after the hoteling event.

In some embodiments, the charge parameter is a learned parameter based on historical hoteling data.

Another embodiment relates to an electric auxiliary power distribution system for a hybrid electric vehicle, including: a battery pack; a power system configured to supply power to the battery pack from an engine; and a controller communicably coupled to the power system, the controller configured to: determine a threshold state of charge for hoteling; determine an estimated time period until a vehicle reaches a hoteling location based on a pre-hoteling condition; determine a charge period based on the threshold state of charge; and control the power system to prioritize charging of the battery pack when the estimated time period is within the charge period.

In some embodiments, the controller is configured to prioritize charging of the battery pack by reducing torque assist below a torque assist threshold.

In some embodiments, the controller is further configured to control the power system to prioritize transit operations when the estimated time period is outside of the charge period.

In some embodiments, the controller is further configured to: maintain the battery pack below a lower charge threshold when the estimated time period is outside of the charge period; and charge the battery pack above the lower charge threshold when the estimated time period is within the charge period.

In some embodiments, the controller is configured to maintain operation of the engine at a high efficiency operating condition during regenerative braking when the estimated time period is within the charge period.

In some embodiments, the controller is further configured to iteratively update the estimated time period based on traffic conditions.

In some embodiments, the controller is configured to prioritize charging of the battery pack by continuously increasing a state of charge of the battery pack as the vehicle approaches a hoteling location.

Another embodiment relates to a method of charging a battery pack for a hybrid electric vehicle using an electric auxiliary power distribution system. The method includes: receiving, from a charge determination module of the electric auxiliary power distribution system, a charge parameter associated with a hoteling event of the hybrid electric vehicle; determining, by a controller, a threshold state of charge based on the charge parameter; and controlling, by the controller, a power system to increase a state of charge of the battery pack to satisfy the threshold state of charge.

Another embodiment of the present disclosure relates to an electric auxiliary power distribution system for a hybrid electric vehicle. The electric auxiliary power distribution system includes a battery pack, a power system, a location sensor, a charge determination module, and a controller. The power system is configured to supply power to the battery pack from a fuel source. The location sensor is configured to generate location data indicative of a geographic location of the hybrid electric vehicle. The controller is communicably coupled to the power system, the location sensor, and the charge determination module. The controller is configured to: receive, from the charge determination module, a charge parameter; determine a threshold state of charge based on the charge parameter; determine, based on the location data, a charge duration; and control the power system to increase a state of charge of the battery pack to satisfy the threshold state of charge within the charge duration.

These and other features, together with the organization and manner of operation thereof, will become apparent from the following detailed description when taken in conjunction with the accompanying drawings.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a block diagram of a hybrid electric sleeper cab vehicle that includes an electric auxiliary power distribution system, according to an embodiment.

FIG. 2 is a block diagram of a control system for an electric auxiliary power distribution system, according to an embodiment.

FIG. 3 is a flow diagram of a method of controlling a generator of an electric auxiliary power distribution system, according to an embodiment.

FIG. 4 is a flow diagram of a method of determining a threshold state of charge of a battery pack of a hybrid electric sleeper cab vehicle based on a hoteling condition, according to an embodiment.

FIG. 5 is a flow diagram of a method of controlling a power split between an engine and a battery pack of a hybrid electric sleeper cab vehicle, according to an embodiment.

FIG. 6 is a block diagram of a vehicle route for a hybrid electric sleeper cab vehicle, according to an embodiment.

FIG. 7 is a block diagram of a hybrid electric sleeper cab vehicle that includes an electric auxiliary power distribution system, according to another embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate to an electric auxiliary power distribution system for a hybrid electric vehicle that is configured to power and control sleeper loads associated with a sleeper compartment onboard the hybrid electric vehicle using batteries (e.g., high voltage batteries) that are also used to power movement of the hybrid electric vehicle. In some embodiments, the sleeper loads include heating and/or cooling equipment that are configured to condition the sleeper compartment of the hybrid electric vehicle. In some embodiments, the electric auxiliary power distribution system includes an electric auxiliary power unit (E-APU) including a DC-to-DC converter that is configured to reduce the voltage from the batteries to satisfy sleeper loads having a lower operating voltage than the batteries. Such an arrangement can eliminate the need for a separate set of low voltage batteries to power operation of the sleeper loads.

In some embodiments, the electric auxiliary power distribution system includes a generator configured to supply power to the battery pack from the engine system. In some embodiments, the E-APU is configured to automatically control operation of the generator and/or an engine system onboard the hybrid electric vehicle to charge the high voltage batteries in preparation for hoteling.

As used herein, “hoteling” refers to a form of vehicle operation in which the vehicle is stationary, but the driver remains within the vehicle and generally within the sleeper compartment of the vehicle. During hoteling, the driver may use the sleeper compartment as a temporary living space, similar to staying in a hotel.

In some embodiments, the E-APU may be configured to perform predictive lookahead charging of the high voltage batteries in anticipation of hoteling based on user inputs, a location of the vehicle, and/or a desired duration of hoteling. For example, the E-APU may be configured to control a charge rate to increase a state of charge of the batteries based on an anticipated duration of hoteling and a distance between the hybrid electric vehicle and the hoteling location. Such an arrangement can reduce operating requirement for the engine of the hybrid electric vehicle during hoteling, which can improve user comfort, reduce noise, and improve vehicle efficiency.

In some embodiments, the E-APU is configured to coordinate operation of other vehicle systems of the hybrid electric vehicle in preparation for hoteling. For example, the E-APU may be configured to control heating and/or cooling systems to precondition the sleeper compartment based on environmental conditions outside of the vehicle, which can reduce power requirements on the batteries during hoteling.

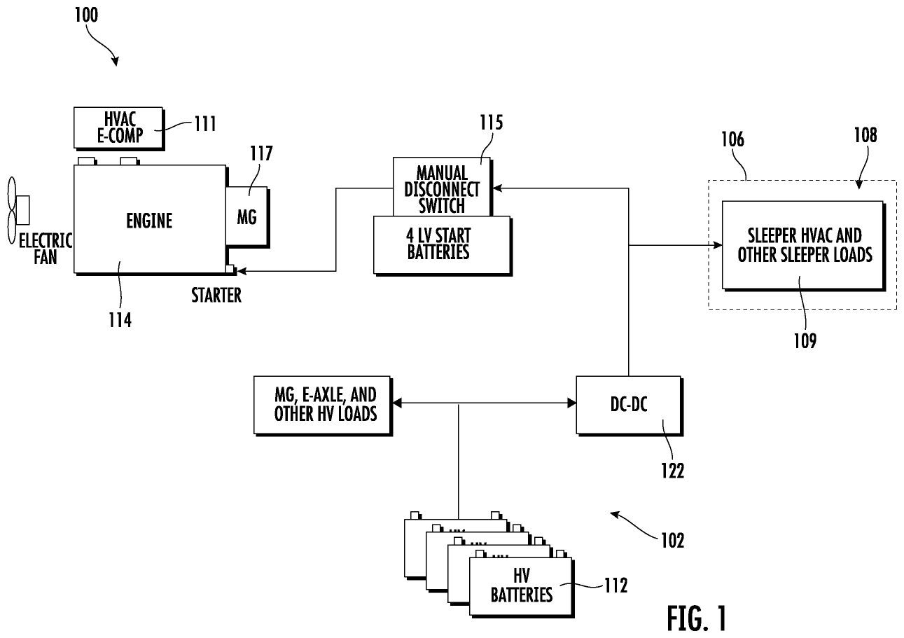

Referring to FIG. 1, a hybrid electric vehicle, shown as vehicle 100, that includes an electric auxiliary power distribution system 102 is shown, according to an embodiment. In some embodiments, the vehicle 100 combines a fueled prime mover, shown as engine system 104, with an electric propulsion system.

In some embodiments, the engine system 104 includes a diesel engine powered by diesel fuel. In other embodiments, the engine system 104 includes another form of internal combustion engine system, or combination of engine systems, such as an engine fueled by natural gas, gasoline, hydrogen, propane, or another fuel source. In other embodiments, the prime mover may include a battery-electric drive system (e.g., a motor-generator unit as described herein) instead of, or in addition to, an internal combustion engine. In yet other embodiments, the prime mover may include a fuel cell instead of, or in addition to, an internal combustion engine.

In some embodiments, the vehicle 100 is a plugin style vehicle that also includes a shore connector, a charge port, or another type of electrical connector that is configured to enable charging of an energy storage device onboard the vehicle 100 using line power (e.g., a 120V power source, a 240V power source, etc.). In other embodiments, the vehicle 100 is a non-plugin style vehicle that is configured to power the energy storage device by operation of the prime mover only.

In the embodiment of FIG. 1, the vehicle 100 is an on-highway vehicle, such as a line-haul vehicle (e.g., a line-haul truck, a semi-truck), that is configured to facilitate commercial transportation of various products. The vehicle 100 includes a cab 106 defining a cabin (not shown) supporting control equipment for the vehicle 100; and a sleeper compartment 108 (e.g., a sleeper cab) which may be configured as a temporary living space for the driver. In some embodiments, the sleeper compartment 108 is a separate area of the cab 106 that extends rearward of the cabin. In some embodiments, the sleeper compartment 108 includes a bed and a climate control system 109 which may form part of, or operate independently from, a cabin climate control system 111 for heating and/or cooling the cabin (and/or for providing other heating/cooling loads to other components of the vehicle 100).

In some embodiments, the vehicle 100 includes a second energy storage device, shown as batteries 113, that is configured to power operation of a starter for the engine system 104. In the embodiment of FIG. 1, the batteries 113 include four low voltage batteries (e.g., 12V batteries).

In some embodiments, and as shown, the vehicle 100 also includes a disconnect 115 configured to selectively electrically connect the batteries 113 to other components onboard the vehicle 100. In some embodiments, the disconnect 115 is a manual disconnect switch configured to selectively couple the batteries 113 to the starter, the climate control system 109, and/or a DC-to-DC converter 122. Such an arrangement can help maintain charge of the batteries 113 under certain operating conditions and can reduce electrical risks to technicians during service and/or when replacing the batteries 113.

The climate control system 109 is coupled to the cab 106 and is configured to cool and/or heat the sleeper compartment 108. In some embodiments, the climate control system 109 includes a heater, which may include an electric heater (e.g., an electrical resistance heater), a forced air heater that transfers heat to the cab 106 from the engine system 104, a fuel-fired heater, and/or a heat pump. The climate control system 109 may also include an air conditioning unit, a ventilation system to facilitate cooling and/or to direct cold air from an outside environment into the cab 106, and/or another type of vehicle heating, ventilation, and/or air conditioning (HVAC) system.

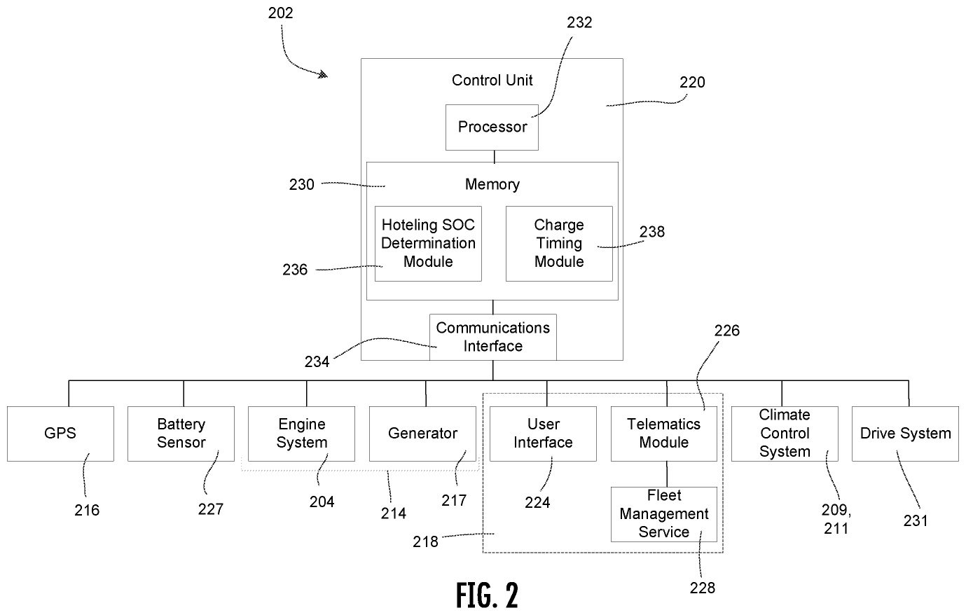

The vehicle 100 also includes an electric auxiliary power distribution system 102. Referring to FIG. 2, an electric auxiliary power distribution system 202 for a vehicle is shown, according to an embodiment. The electric auxiliary power distribution system 202 includes an energy storage device (e.g., the battery pack 112 of FIG. 1); a power system 214 configured to supply power to the battery pack 212; a charge determination module 218; and a controller 220. The power system 214 is configured to supply power to the battery pack from an engine system 204. The controller 220 is communicably coupled to the power system and the charge determination module 218. The controller 220 is configured to receive, from the charge determination module 218, a charge parameter; determine a threshold state of charge based on the charge parameter; and control the power system 214 to increase a state of charge of the battery pack 212 to satisfy the threshold state of charge.

In some embodiments, the electric auxiliary power distribution system 202 includes the battery pack; the power system 214 configured to supply power to the battery pack from an engine; and a controller 220 communicably coupled to the power system 214. The controller 220 is configured to: determine a threshold state of charge for hoteling; determine an estimated time period until a vehicle reaches a hoteling location based on a pre-hoteling condition; determine a charge period based on the threshold state of charge; and control the power system 214 to prioritize charging of the battery pack when the estimated time period is within the charge period.

In some embodiments, the electric auxiliary power distribution system 202 also includes a drive system 231 configured to control drive parameters, such as speed (e.g., engine speed), acceleration, and regenerative braking. In some embodiments, the drive system 231 is or forms part of a cruise control system for the vehicle (e.g., a predictive cruise control system) and/or an engine control unit for the vehicle.

For example, the controller 220 may be integrated with or communicably coupled to a predictive cruise control (PCC) system of the vehicle. The PCC system is configured to modulate one or more drive parameters—such as vehicle speed, acceleration limit, torque-assist magnitude, and regenerative-braking intensity—based on route look-ahead data and hoteling predictions. The controller 220 may exchange data with the PCC system over the communication interface 234 to coordinate these drive parameters so that, as an anticipated hoteling event approaches, the vehicle reduces electrical torque-assist usage, increases opportunities for regenerative braking, and maintains operation of the engine at a high brake-thermal-efficiency condition for charging the battery pack 212.

In some implementations, the PCC system or the controller 220 identifies predicted grades, traffic, and speed limits along an upcoming route segment (e.g., based on location data from the location sensor 216) and adjusts cruise speed targets to: (i) increase battery charging when long down-grades or deceleration segments are predicted, and (ii) defer additional charging until the estimated time to hoteling enters a target charge window. Such coordination between the controller 220 and the PCC system can enable predictive energy management that increases the overall efficiency of the electric auxiliary power distribution system 202.

In some embodiments, the vehicle (e.g., the electric auxiliary power distribution system 202) also includes a location sensor 216 configured to generate location data indicative of a geographic location of the vehicle. In some embodiments, the controller 220 is further configured to determine, based on the location data, a charge duration. The controller 220 may be further configured to control the power system 214 to increase a state of charge of the battery pack 212 to satisfy the threshold state of charge within the charge duration.

In some embodiments, and as shown in FIG. 1, the electric auxiliary power distribution system 102 also includes a DC-to-DC converter 122 that is configured to control allocation of power from the battery pack 112 to the climate control system 109. In some embodiments, the controller 220 (FIG. 2) and the DC-to-DC converter 122 together form at least part of an electric auxiliary power control unit (e.g., a control module, a control circuit or combination of circuits) that can be retrofit onto an existing hybrid electric vehicle.

Referring still to FIG. 1, the battery pack 112 is configured to provide power to various subsystems onboard the vehicle 100. In some embodiments, the battery pack 112 includes a high voltage battery having an operating voltage that is greater than the batteries 113 (e.g., within a range from about 400V to 800V inclusive, or greater, whereas the batteries 113 may have a voltage within a range from about 12V to 24V inclusive). In some embodiments, the battery pack 112 is electrically coupled to and/or between the DC-to-DC converter 122 and the power system 114 (e.g., the motor-generator unit).

In some embodiments, the battery pack 112 is also coupled to other high voltage loads onboard the vehicle 100, such as an E-axle, wheel motors, and/or other high voltage components. For example, the battery pack 112 may be configured to power movement of the vehicle 100 via the E-axle and/or wheel motors onboard the vehicle 100 in addition to powering operation of the climate control system through the DC-to-DC converter 122.

The power system 114 (the power system 214 of FIG. 2) is configured to receive mechanical power from a fuel source (e.g., diesel fuel, natural gas, gasoline, etc.) and to convert the mechanical power to electrical energy to charge the battery pack 112. In some embodiments, the power system 114 includes (i) the engine system 104 and (ii) a generator or a motor-generator unit 117 that is also configured to convert electrical energy stored in the battery pack 112 to power movement of the vehicle (e.g., to drive the wheels). In some embodiments, and as shown, the motor-generator unit 117 is directly mechanically coupled to an engine of the engine system 104. In other embodiments, the motor-generator unit 117 is coupled to the engine through a transmission, an axle, or another component.

Referring to FIG. 2, the location sensor 216 is configured to generate location data indicative of a geographic location of the vehicle. In the embodiment of FIG. 2, the location sensor 216 is part of a global positioning system (GPS) that is coupled to the vehicle chassis, cab, engine system, or another part of the vehicle.

The charge determination module 218 is configured to receive and transmit a charge parameter indicative of a desired state of charge of the vehicle during (e.g., prior to, at the onset of) hoteling. In some embodiments, the charge parameter is, or corresponds with, a duration of hoteling that is desired by the driver. For example, the charge parameter may be a number of hours, nights, and/or days that the driver plans to remain at a rest stop or other location in between transit operations. In other embodiments, the charge parameter may be a desired charge level of the battery pack (e.g., 80% charge, 90% charge, 100% charge, etc.), or another parameter associated with an anticipated hoteling operation.

In other embodiments, the charge parameter includes an anticipated duration or time period of vehicle operation in transit until hoteling commences.

In still further embodiments, the charge parameter includes at least one parameter indicative of an anticipated energy demand associated with the hoteling event (e.g., a predicted cooling and/or heating load during hoteling) and/or a post-hoteling vehicle operation (e.g., an vehicle operating speed and/or acceleration when departing from the hoteling location).

Referring still to FIG. 2, in some embodiments, the charge determination module 218 includes a human-machine interface, shown as user interface 224, that is configured to receive a user input indicative of a desired operating duration of the climate control system 209 (the climate control system 109 of FIG. 1) of the hybrid electric vehicle during hoteling. In some embodiments, the user interface 224 includes a display (e.g., a touch screen display). In other embodiments, the user interface 224 includes a button, lever, switch, sensor, or another form of actuator that is configured to receive and transmit user input to the controller 220.

For example, the user interface 224 may include a button that is preconfigured to transmit one of (i) a charge parameter corresponding to a fixed hoteling duration (e.g., one night, two nights, etc.), or (ii) a time period of anticipated vehicle operation until hoteling commences (e.g., 1 hour, 2 hours, etc.). The button and/or the controller 220 may be configured to allow a user to increment the charge parameter responsive to a user pressing the button multiple times (e.g., where each press of the button adds one hour to the anticipated hoteling duration, etc.). In some embodiments, the user interface 224 includes a touchscreen interface or another form of user interface that is configured to allow a user to specify charge parameters corresponding with anticipated conditions during hoteling.

In some embodiments, the user interface 224 is configured to receive multiple charge parameters from a user, such as both the planned hoteling duration and the time period of anticipated vehicle operation until hoteling commences.

In some embodiments, the charge determination module 218 includes a telematics module 226 (e.g., a telematics unit, a telematics circuit) that is configured to communicably couple the controller 220 to a fleet management service 228, the Internet, and/or another remote system. In some embodiments, the telematics module 226 includes a transceiver configured to transmit over a cellular network or another wireless communications protocol. The controller 220 may be configured to receive a charge parameter, such as a planned hoteling duration, a desired temperature and/or other climate condition within the cab during hoteling, a traffic report indicative of anticipated traffic conditions in the vicinity of the vehicle (e.g., along an adjacent highway or intended path of travel) after hoteling is complete, a speed limit of the roadway adjacent the hoteling location and/or along a path of travel, a forecast temperature corresponding with completion of hoteling, and/or another condition indicative of a desired state of charge of the vehicle for hoteling and/or post-hoteling operations.

In some embodiments, and as shown in FIG. 2, the electric auxiliary power distribution system 202 also includes a battery sensor 227 configured to generate charge data indicative of a state of charge of the battery pack (the battery pack 112 of FIG. 1). In such implementations, the battery sensor 227 may be electrically connected to the battery pack. In some embodiments, the battery sensor 227 includes a current and/or voltage sensor that is configured to monitor real-time operating conditions of the battery pack.

Referring still to FIG. 2, the controller 220 is configured to receive and interpret data from other components of the electric auxiliary power distribution system 202 (e.g., the location sensor 216, the charge determination module 218, etc.) and to control operation of the power system 214, and/or the climate control system 209. In some embodiments, the controller 220 forms at least part of an engine control unit (e.g., an engine control module, an engine control circuit, or combination of circuits, etc.) for the engine system 204.

In the embodiment of FIG. 2, the controller 220 includes memory 230 storing machine-readable instructions thereon, and a processor 232 communicably coupled to the memory 230 and configured to execute the machine-readable instructions to perform any of the processes and/or control methods described herein. In some embodiments, the processor 232 is one of multiple processors or processing circuits that are configured to control operations of the electric auxiliary power distribution system 202.

The controller 220 also includes a communication interface 234 configured to communicably couple the controller 220 to other components of the electric auxiliary power distribution system 202, including the power system 214, the climate control system 209, the location sensor 216, the charge determination module 218, and/or the battery sensor 227. In some embodiments, the communication interface 234 includes a controller area network (CAN) bus onboard the vehicle. In other embodiments, the communication interface 234 may include another wired or wireless protocol.

In some embodiments, the controller 220 further includes a hoteling state of charge (SOC) determination module 236 and a charge timing module 238. In some embodiments, the hoteling SOC determination module 236 and/or the charge timing module 238 are control circuits that are communicably coupled to the controller 220. In some embodiments, the hoteling SOC determination module 236 and/or the charge timing module 238 are configured as modules in memory 230 of the controller 220 (e.g., as machine readable instructions that, when executed by the processor 232, cause the processor 232 to perform any of the operations described herein).

For example, the hoteling SOC determination module 236 may be configured to determine, based on one or more charge parameters, the threshold state of charge to satisfy the hoteling load and/or certain post-hoteling operations. In some embodiments, the SOC determination module 236 is configured to determine the threshold state of charge based on a combination of a hoteling condition that occurs during a hoteling event (e.g., an air conditioning and/or heating load, etc.), and a post-hoteling vehicle operating condition that occurs after the hoteling event (e.g., an energy required to increase vehicle speed from a stopped condition to a speed limit along a route adjacent to the hoteling area, etc.). In some embodiments, the charge timing module 238 is configured to determine, based on one or more charge parameters, a charge duration (e.g., a charge delay, a charge period, a rate of charge, etc.).

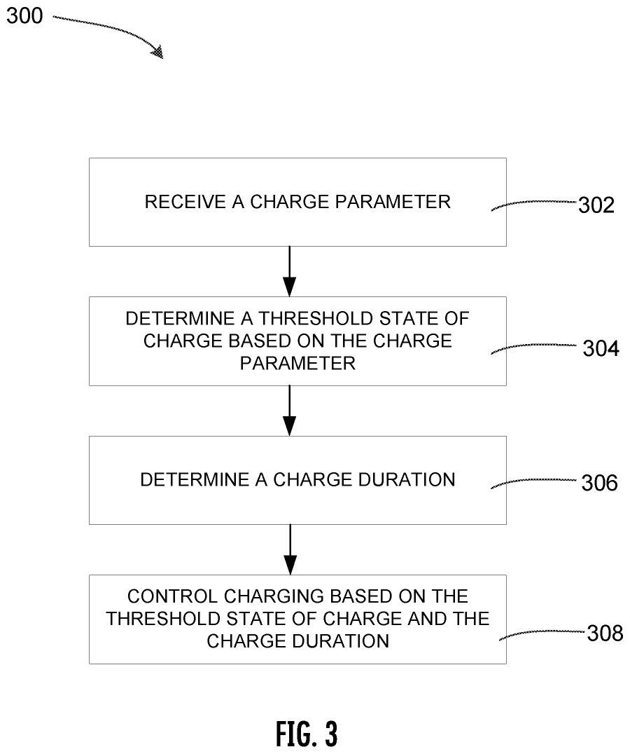

Referring to FIG. 3, a method 300 of controlling a power system for a hybrid electric sleeper vehicle is shown, according to an embodiment. The method 300 may be implemented by the electric auxiliary power distribution system 202 of FIG. 2 (e.g., the controller 220, the hoteling SOC determination module 236, the charge timing module 238) and will therefore be described with reference to FIG. 2. In other embodiments, the method 300 may include additional, fewer, and/or different operations.

In some embodiments, the method 300 includes receiving, from a charge determination module of the electric auxiliary power distribution system, a charge parameter associated with a hoteling event of the hybrid electric vehicle; determining, by a controller, a threshold state of charge based on the charge parameter; and controlling, by the controller, a power system to increase a state of charge of the battery pack to satisfy the threshold state of charge.

The method 300 includes receiving a charge parameter, at operation 302. In some embodiments, operation 302 includes receiving the charge parameter by a controller (e.g., the controller 220) from a charge determination module (e.g., the charge determination module 218). For example, operation 302 may include receiving, from a user interface (e.g., the user interface 224), a user input that is indicative of a desired operating duration of a climate control system of the hybrid electric vehicle during hoteling. In some embodiments, operation 302 includes receiving a charge parameter derived from learned user preferences associated with prior hoteling events. For example, the controller 220 may access historical data stored in the memory 230 reflecting prior hoteling durations, frequencies, and climate preferences to generate a charge parameter without requiring active input from the driver. In some embodiments, the controller 220 updates the charge parameter over time as additional hoteling events are recorded, such that the charge parameter reflects a pattern of recurring hoteling at a particular location, a recurring hoteling duration associated with a given route, or a recurring climate set point observed across multiple hoteling events.

In other embodiments, operation 302 may include receiving the charge parameter from a fleet management service that is communicably coupled to the vehicle. For example, operation 302 may include receiving, from a telematics module in communication with the fleet management service (e.g., telematics module 226), a time period of hoteling that corresponds with a hoteling location (e.g., a rest stop, etc.) that is nearest to the vehicle based on the vehicle location.

For example, in some embodiments, operation 302 includes receiving a lookup table from the fleet management service (e.g., a fleet database of the fleet management service) that includes a pre-programmed list of charge parameters that correspond with different locations. In such implementations, operation 302 may include presenting different hoteling location options to a user, and determining, by iterating through the lookup table, the charge parameter that corresponds with the user-specified hoteling location.

By enabling receipt of charge parameters through the telematics module, the electric auxiliary power distribution systems of the present application can enable real-time state of charge adjustments over-the-air with fleet connectivity based on what scenarios are happening at the fleet level (e.g., to other vehicles in the fleet), and plans for vehicles to hotel at different times and/or locations. Such an approach can also enable identification and flagging of hoteling locations that include charging stations or access to line power (in which case the charge parameter may be set to zero, or another value that eliminates any additional pre-hoteling charging operations, which can reduce emissions during vehicle transit operations).

In some embodiments, the charge parameter includes one or more post-hoteling conditions (e.g., post-hoteling vehicle operating conditions) that affect an anticipated power demand of the battery pack after the hoteling event concludes, such as during a predicted time period where the engine temperature is below nominal values during sustained engine operation. For example, the charge parameter may include predicted traffic conditions along a road segment departing the hoteling location, where high predicted traffic density increases the required threshold state of charge to preserve torque assist capacity for acceleration and merging operations following the hoteling event. In some embodiments, the charge parameter includes a route-based condition associated with the road segment departing the hoteling location, such as an altitude change, a road grade, a slope, a number and/or degree of turns, or other route-based conditions. For example, the charge parameter may include a positive grade that requires increased power demand from the power system 214. By accounting for post-hoteling power demand, the controller 220 to set a threshold state of charge that satisfies both the hoteling load and the anticipated propulsion demands immediately following the hoteling event, such as torque assist for merging and acceleration when the engine system 204 is below nominal operating temperature and the after-treatment system thermal load increases fuel consumption.

The method 300 also includes determining (e.g., by the controller 220) a threshold state of charge based on the charge parameter, at operation 304. The threshold state of charge may be a percentage charge of the battery pack, a voltage level of the battery pack, or another parameter indicative of a desired operating capacity of the battery pack. In some embodiments, operation 304 includes accessing a threshold charge lookup table stored in memory of the controller and iterating through the threshold charge lookup table to identify the threshold state of charge that corresponds with the charge parameter.

In some embodiments, operation 304 includes using an algorithm of threshold charge as a function of the charge parameter. For example, operation 304 may include determining an amount of energy required to power the climate control system that corresponds with (i) an anticipated duration of hoteling, (ii) a set point for the climate control system input by the user, (iii) an outdoor environmental condition (e.g., a local outdoor temperature and/or a predicted weather condition in an environment surrounding the vehicle during hoteling as determined through the Internet based on the vehicle's location, etc.), and/or (iv) post hoteling conditions. In such embodiments, operation 304 may include adjusting the threshold state of charge to account for increased heating or cooling requirements based on received and/or anticipated environmental conditions outside the vehicle during hoteling.

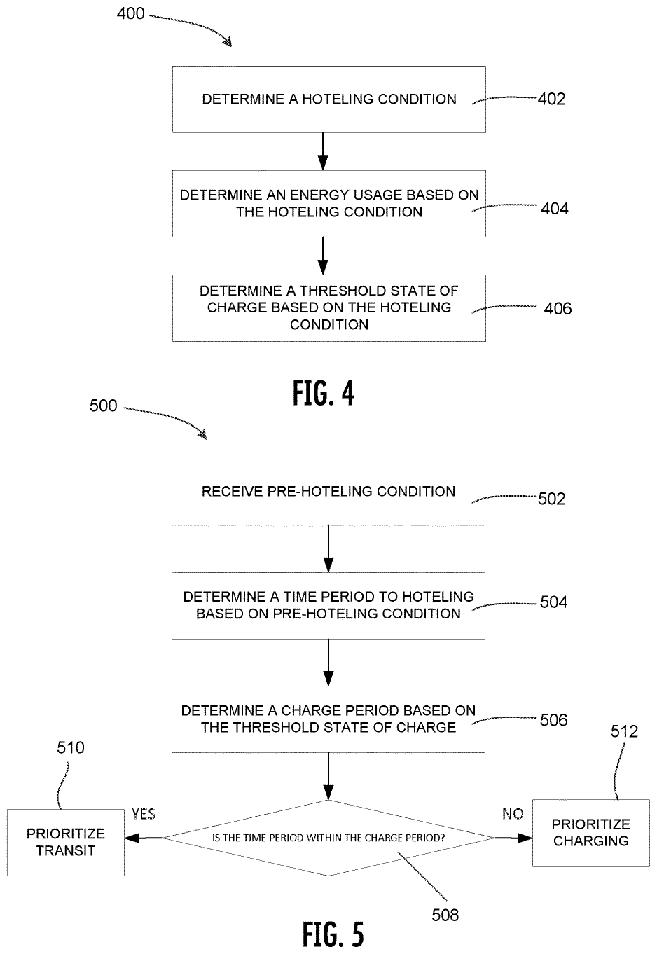

Referring to FIG. 4, a method 400 of determining a threshold state of charge of the battery pack based on the charge parameter(s) is shown, according to an embodiment. The method 400 may be implemented by the electric auxiliary power distribution system 202 of FIG. 2 (e.g., the controller 220, the hoteling SOC determination module 236) and will therefore be described with reference to FIG. 2. In other embodiments, the method 400 may include additional, fewer, and/or different operations.

The method 400 includes determining a hoteling condition, at operation 402. The hoteling condition may include any parameter indicative of anticipated conditions during a hoteling event and/or post-hoteling vehicle operations. In some embodiments, the hoteling condition is determined directly from a charge parameter. In other embodiments, the hoteling condition is derived from a charge parameter through an intermediate calculation.

For example, a charge parameter indicative of a predicted outdoor temperature at a hoteling location may be used by the controller 220 to determine a temperature differential between the sleeper compartment and the outdoor environment as the hoteling condition, where that temperature differential represents the thermal load that the climate control system 209 is anticipated to satisfy during the hoteling event. In some embodiments, the hoteling condition includes a predicted ambient temperature, a predicted humidity level, a predicted windchill, an anticipated duration of the hoteling event, a predicted weather condition at a hoteling location at the time of arrival and/or across the duration/time period of the hoteling event, a route-based condition associated with travel after the hoteling event (e.g., an altitude change, a road grade, a slope, etc.), a predicted traffic condition along a road segment departing the hoteling location, and/or another condition associated with the hoteling event.

In some embodiments, the controller 220 receives the charge parameter from which the hoteling condition is derived via the communication interface 234. For example, the telematics module 226 may receive route data from the fleet management service 228 that includes predicted weather at a destination, layover, or next break, and the controller 220 may derive the hoteling condition from that route data at operation 402. In some embodiments, the hoteling condition includes both a condition anticipated at the start of the hoteling event and a condition anticipated at the end of the hoteling event, or at another point or points during the hoteling event, such that the controller 220 accounts for temporal variation in heating or cooling demand over the hoteling interval.

The method 400 includes determining an energy usage based on the hoteling condition, at operation 404. The controller 220 determines, based on the hoteling condition from operation 402, an amount of energy anticipated to be consumed by the climate control system 209 during the hoteling event.

In some embodiments, the controller 220 determines the energy usage based on both predicted ambient temperature and predicted humidity at the start and/or end of the hoteling event. For example, where predicted windchill at the hoteling location indicates a high heating demand, the controller 220 may increase the threshold state of charge to account for the elevated heating load on the climate control system 209. By way of another example, if the predicted humidity at the hoteling location is high during the time of the hoteling event (e.g., based on a weather forecast), but the temperature is within a comfortable range for the operator, the energy usage can account for cooling load to dehumidify the air within the sleeper cab.

In some embodiments, the controller 220 determines the energy usage by averaging the hoteling condition at the start of the hoteling event and the hoteling condition at the end of the hoteling event, or at multiple points during the hoteling event. For example, where the predicted ambient temperature at the beginning of the hoteling event differs from the predicted ambient temperature at the end of the hoteling event, the controller 220 may average those two temperature values to determine an average heating or cooling demand over the hoteling interval. In some embodiments, the controller 220 determines the energy usage by stepping through time segments or integrating over the hoteling interval to account for non-linear variation in the hoteling load. For example, the controller 220 may segment the hoteling interval into discrete time periods, determine a predicted heating or cooling demand for each segment based on predicted ambient conditions during that segment, and sum the resulting energy demand values across all segments to determine the total energy usage. Such a segmented or integrated approach can provide a more accurate energy usage estimate than averaging alone when the hoteling load varies across the hoteling interval in a non-linear manner.

The method 400 also includes determining energy usage associated with post hoteling events. For example, where the telematics module 226 receives route data indicating a steep uphill segment immediately following the hoteling location, the controller 220 determines the energy required to preserve torque assist capacity in the battery pack for propulsion along that segment after the hoteling event concludes. The controller 220 may also increase predicted energy usage when the hoteling condition includes a predicted traffic condition indicating high traffic density along the road segment departing the hoteling location, to preserve torque assist capacity for acceleration and merging operations after the hoteling event. In some embodiments, the controller 220 adjusts the threshold state of charge based on a route-based condition associated with travel after the hoteling event, such as an altitude, road grade, or slope that increases anticipated power demand from the power system 214.

The method 400 includes determining a threshold state of charge based on the hoteling condition, at operation 406. For example, in some embodiments, the hoteling SOC determination module 236 is configured to determine the threshold state of charge by determining a state of charge of the battery pack that corresponds with the energy determined in operation 404 (e.g., a state of charge that satisfies the predicted energy usage associated with hoteling and certain post-hoteling operations). In some embodiments, the controller 220 determines the threshold state of charge by combining both the anticipated hoteling load and the anticipated post-hoteling power demand into a single target value, such that the power system 214 charges the battery pack to a level sufficient to satisfy both demands prior to the hoteling event.

In some embodiments, the threshold state of charge is an empirical value based on vehicle field test data of other vehicles under similar operating conditions (e.g., historical test data of similar vehicle configurations).

Returning to FIG. 3, in some embodiments, the method 300 further includes determining a charge duration, at operation 306. The charge duration is a time period during which the vehicle will remain in transit before reaching the hoteling location (e.g., a time period until hoteling commences). In some embodiments, the charge duration corresponds with a distance, an operating speed of the vehicle, and/or another vehicle operating parameter.

In some embodiments, operation 306 includes receiving, from a GPS onboard the vehicle, a distance between a current location of the vehicle and a hoteling location, and/or an estimated duration of operation of the vehicle prior to hoteling. In other embodiments, operation 306 includes receiving, from a location sensor onboard the vehicle (e.g., the location sensor), location data indicative of a geographical position of the vehicle and determining (e.g., by the controller 220), based on the location data, a distance between the hybrid electric vehicle and a hoteling location. Operation 306 may also include determining the charge duration by comparing the distance with a real-time vehicle operating speed and/or a predicted operating speed based on data from a GPS onboard the vehicle and/or other vehicle sensors (e.g., a vehicle speed sensor, etc.).

The method 300 further includes controlling charging of the battery pack based on the threshold state of charge and/or the charge duration, at operation 308. In some embodiments, operation 308 includes determining a charge delay (e.g., a period during which no additional charging needs to be performed) based on a user or fleet selected hoteling location. For example, operation 308 may include determining, based on the threshold state of charge, and performance parameters for the power system stored in memory, that charging can be deferred until the vehicle is within a threshold distance and/or time period away from the hoteling location. Such an approach can help maintain the battery pack at a more efficient state of charge for vehicle transit operations until the vehicle comes within the threshold distance and/or time period from the hoteling location.

In some embodiments, operation 308 includes determining a charge rate of the battery pack needed to satisfy (e.g., to equal, to exceed, to exceed by a threshold value, etc.) the threshold state of charge within the charge duration. In some embodiments, operation 308 includes receiving charge data from a battery sensor (e.g., the battery sensor 227) that is indicative of the state of charge of the battery pack. In such embodiments, operation 308 may further include determining the charge rate based on the state of charge, the charge duration, and the threshold state of charge. Such an operation can result in different charge rates depending on the distance of the vehicle from the hoteling location and the speed of the vehicle.

Referring to FIG. 5, a method 500 of determining whether to prioritize transit operations or charging operations based on a pre-hoteling condition and a charge period is shown, according to an embodiment. The method 500 may be implemented by the electric auxiliary power distribution system 202 of FIG. 2 (e.g., the controller 220, the charge timing module 238) and will therefore be described with reference to FIG. 2. In other embodiments, the method 500 may include additional, fewer, and/or different operations.

The method 500 includes receiving a pre-hoteling condition, at operation 502. The pre-hoteling condition includes any parameter or set of parameters that the vehicle will encounter prior to the hoteling event. In some embodiments, the pre-hoteling condition is determined directly from the charge parameter or is derived from the charge parameter by the controller 220. For example, the pre-hoteling condition may include a predicted traffic condition along the route prior to the hoteling location, a road grade or slope along the route prior to the hoteling location, a predicted weather condition encountered during transit, and/or a distance between the current geographic location of the vehicle and the hoteling location, among others. In some embodiments, the pre-hoteling condition is received by the controller 220 via the communication interface 234 from the telematics module 226, the GPS, and/or the user interface 224.

The method 500 includes determining a time period to hoteling based on the pre-hoteling condition, at operation 504. The controller 220 determines, based on the pre-hoteling condition from operation 502, an estimated time period remaining until the vehicle reaches the hoteling location. In some embodiments, the controller 220 determines the time period to hoteling based on a distance between the current geographic location of the vehicle and the hoteling location, a predicted vehicle operating speed, and/or a predicted traffic condition along the route. For example, where the pre-hoteling condition includes a predicted high-traffic segment prior to the hoteling location, the controller 220 may reduce the estimated vehicle operating speed across that segment, thereby increasing the estimated time period to hoteling relative to an uncongested route. In some embodiments, the charge timing module 238 iteratively updates the time period to hoteling as the vehicle traverses the route and as updated pre-hoteling conditions are received.

In some embodiments, operation 504 also includes comparing the estimated time period to hoteling against a desired or required break interval for the operator. For example, where the controller 220 receives, via the telematics module 226, predicted traffic data indicating high traffic density along the route prior to the hoteling location, the controller 220 may determine that the estimated time period to hoteling—when accounting for stop-and-go conditions—falls within or exceeds a required break interval for the operator before the planned hoteling location is reached. In such a circumstance, operation 504 may include identifying and/or rerouting the vehicle to a hoteling location that is closer to the vehicle's current location, and/or generating a recommendation, transmitted to the operator via the user interface 224, to commence hoteling at an earlier stop along the route rather than continuing to the planned hoteling location.

Where predicted stop-and-go traffic ahead of the planned hoteling location would otherwise deplete the battery pack through torque assist operations during low-speed transit, taking an earlier break at an available rest stop can allow the battery pack to retain a higher state of charge in preparation for the hoteling event. In some embodiments, the controller 220 determines the availability of an earlier stop based on route data received from the fleet management service 228 and/or the GPS and compares the state of charge of the battery pack at the earlier stop against the threshold state of charge to confirm that the battery pack would satisfy the hoteling load at the alternative location.

The method 500 includes determining a charge period based on the threshold state of charge, at operation 506. For example, the method 500 may include, based on the threshold state of charge from the hoteling SOC determination module 236 (e.g., from the method 400 of FIG. 4) and a current state of charge of the battery pack as measured by the battery sensor 227, the charge period. The charge period corresponds to a time required to increase the state of charge of the battery pack from its current level to the threshold state of charge.

In some embodiments, the controller 220 determines the charge period based on an available charge rate from the power system 214, which may vary depending on operating conditions of the engine system 204 and the motor-generator unit 217. For example, where the battery pack is at a lower state of charge, the battery pack may accept charge at a higher instantaneous rate relative to a battery pack that is closer to the threshold state of charge, such that the charge period may be shorter when the state of charge of the battery pack is lower.

The method 500 includes determining, based on the charge period and the time period to hoteling, when the controller 220 transitions from prioritizing transit operations to prioritizing charging operations in preparation for the hoteling event. The method 500 includes determining whether the time period to hoteling is within the charge period, at operation 508. In some embodiments, operation 508 includes comparing the time period to hoteling from operation 504 against the charge period from operation 506. When the time period to hoteling is outside of the charge period (i.e., the vehicle is sufficiently far from the hoteling location that the battery pack does not yet require charging to reach the threshold state of charge), the controller 220 prioritizes transit operations, at operation 510.

In some embodiments, prioritizing transit operations (operation 510) includes maintaining the state of charge of the battery pack at a lower level, such as below a lower threshold state of charge, permitting the power system 214 to allocate engine output toward propulsion rather than charging, and/or permitting torque assist from the battery pack to facilitate fuel-efficient vehicle operation. Maintaining the battery pack at a lower state of charge during transit can increase the rate at which the battery pack accepts charge during regenerative braking events and can reduce degradation of the battery pack over time relative to sustained operation at an elevated state of charge.

When the time period to hoteling is within or otherwise satisfies the charge period (i.e., the vehicle is within a distance and/or time threshold of the hoteling location at which charging operations are required to reach the threshold state of charge before the hoteling event), the controller 220 prioritizes charging operations, at operation 512. In some embodiments, prioritizing charging operations (operation 512) includes adjusting the power split between the engine system 204 and the motor-generator unit 217 to increase the rate of charge of the battery pack, reducing or eliminating torque assist from the battery pack for propulsion, and/or modulating a cruise reference speed generated by the drive system 231 to create opportunities for regenerative braking and high brake thermal efficiency charging of the battery pack.

In some embodiments, prioritizing charging operations at operation 512 includes maintaining the state of charge of the battery pack, without regenerative braking. For example, operation 512 may include engaging predictive neutral coasting, a mode of operation in which the drive system 231 decouples the motor-generator unit 217 from the drivetrain during identified coasting opportunities along the route so that the battery pack retains charge. In some embodiments, the controller 220 identifies coasting opportunities based on pre-hoteling conditions received at operation 502, such as a downhill grade or a deceleration segment preceding the hoteling location, and coordinates predictive neutral coasting with modulation of the cruise reference speed generated by the drive system 231 to increase the frequency and duration of regenerative braking and high brake thermal efficiency charging events. In some embodiments, the controller 220 applies predictive neutral coasting in combination with a reduced torque assist threshold so that the battery pack retains charge accumulated during coasting segments rather than drawing that charge toward propulsion torque.

In some embodiments, prioritizing charging operations further includes executing a predictive neutral coasting routine during which the controller 220 temporarily decouples the motor-generator unit 217 from the drivetrain—or commands the drive system 231 to enter a zero-torque state—when upcoming route data indicate downhill grades or other coasting opportunities. The controller 220 may receive grade or topographic information from the location sensor 216 or the telematics module 226, and pre-emptively select these segments to minimize traction power losses and preserve the state of charge of the battery pack 212. In some embodiments, operation 512 includes combining predictive neutral coasting with selective regenerative braking pulses at the end of a grade to recover kinetic energy efficiently and to maintain the engine system 204 within a desired high-efficiency operating zone.

In some embodiments, the controller 220 increases the rate at which charging is prioritized progressively as the vehicle approaches the hoteling location, such that the state of charge of the battery pack ramps upward along the route toward the threshold state of charge as the hoteling event approaches. In some embodiments, the controller 220 continuously (e.g., without substantial interruption) increases the state of charge of the battery pack as the vehicle approaches the hoteling location (e.g., when the time to hoteling is within or otherwise satisfies the charge period).

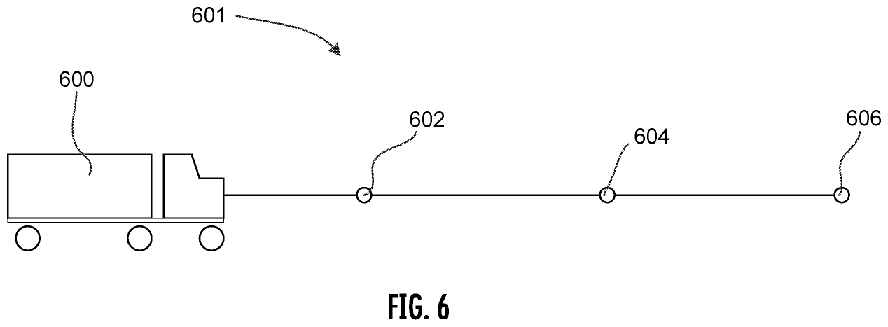

For example, and referring to FIG. 6, a route map 601 for a hybrid electric sleeper vehicle is shown as vehicle 600, according to an embodiment. As shown, the route map 601 includes multiple hoteling locations along the route being traversed by the vehicle 600, shown as a first hoteling location 602, a second hoteling location 604, and a third location 606. Each hoteling location is a different distance from the vehicle 600 along the route. Assuming the same hoteling duration at each location, the electric auxiliary power distribution systems of the present disclosure are configured to adjust the charge delay and/or the charge rate provided by the power system to account for the differences in distance between each hoteling location (e.g., to use higher charge rates for hoteling locations that are closer to the vehicle 600 with no charge delay, to use lower charging rates and/or larger charge delay for hoteling locations that are farther from the vehicle, etc.). Such an approach can provide flexibility to vehicle operators and enhance the overall operating efficiency of the vehicle 600. In some embodiments, and as described above, the controller is also configured to adjust selection of a hoteling location based on a time to hoteling and an operator break interval.

In some embodiments, the controller 220 implements a dynamic power-split algorithm that continuously balances engine load and electric-assist contribution to maximize the rate of high-efficiency battery charging while reducing fuel penalties. The algorithm may adjust the cruise reference speed generated by the drive system 231 and the torque-assist threshold in real time based on predictive information from the PCC system, thereby coordinating both the charging and propulsion strategies as the vehicle approaches a hoteling location.

In some embodiments, operation 512 also includes transmitting (e.g., by the controller 220) a control signal to a power system (e.g., the engine system 204, the motor-generator unit, etc.) onboard the vehicle to supply electrical energy to the battery pack according to the charge delay and/or the charge rate.

In some embodiments, the electric auxiliary power distribution system (e.g., the controller 220) is further configured to control a climate control system (e.g., the climate control system 209, the cabin climate control system 211) onboard the vehicle to reduce loads on the battery pack during hoteling. For example, the controller may be configured to control the cabin climate control system during transit (e.g., during the charge duration, or a portion thereof) to pre-heat the cab to a temperature that is higher than normal, which can reduce loading on the heater for the climate control system during hoteling.

The electric auxiliary power distribution system may be configured to utilize heat generated by the engine system to reduce heating requirements. For example, when the vehicle comes to a stop or arrives at the hoteling location, the engine coolant may remain hot from pre-charging operations.

In some embodiments, the controller is configured to control the cabin climate control system (e.g., a cabin vent heater system) to direct heat from the hot coolant (e.g., from a heat exchanger) and/or a warm engine block of the engine system at the beginning of the hoteling operation to reduce heat loads on the climate control system for the sleeper compartment. In some embodiments, the vehicle may include another form of thermal storage system (e.g., a coolant reservoir, a phase change material, etc.) to retain heat from the engine system for heating the sleeper compartment once the engine system is shut off.

The electric auxiliary power distribution system may also be configured to perform pre-cooling operations using native vehicle equipment (e.g., the cabin climate control system 211) and/or the climate control system for the sleeper compartment, to reduce cooling loads on the battery pack during hoteling. For example, the controller may be configured to pre-cool the cab to a lower temperature than normal during a final portion of a route (e.g., during the charge duration, or a portion thereof) to reduce the cooling load on the battery pack during hoteling.

In some embodiments, the controller is configured to control the cabin climate control system during the final portion of a route to cool a thermal storage system (e.g., a coolant, a phase change material, etc.) to reduce loads on the climate control system for the sleeper compartment at the beginning of hoteling. Such an implementation can enable the use of energy generated by higher efficiency HVAC equipment, such as the cabin air conditioning unit, which can use ram air for cooling a condenser during transit, instead of requiring operation of a fan driven cooler. Such an implementation can further improve overall system efficiency and reduce loads on the battery pack during hoteling.

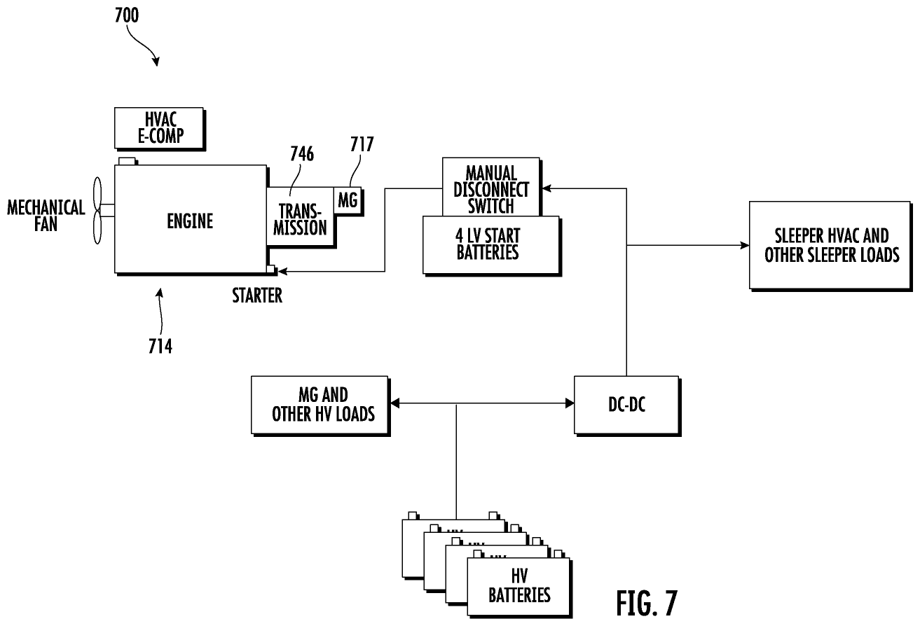

The hybrid electric sleeper vehicle arrangement described with reference to FIGS. 1-2 should not be considered limiting. It should be understood that the electric auxiliary power distribution system of the present application can be used in various different configurations of a hybrid electric vehicle without departing from the inventive principles described herein. For example, and referring to FIG. 7, another embodiment of a hybrid electric sleeper vehicle, shown as vehicle 700, is depicted that includes a different configuration of a power system than vehicle and electric auxiliary power distribution system of FIGS. 1-2.

In the embodiment of FIG. 7, the power system 714 includes a motor-generator unit 717 that is spaced apart from an engine by a transmission 746. Such an arrangement can enable operation of the motor-generator unit 717 at different rotational speeds than the engine, which can improve the overall operating efficiency of the power system 714. The other components of the vehicle 700 are the same as, or substantially similar to, the vehicle 100 of FIG. 1. In other embodiments, the position and/or configuration of the motor-generator unit and engine system may be different. For example, the motor-generator unit may be directly connected to the engine system (e.g., the engine) and disposed in front of or behind the engine system (e.g., a front accessory drive or a rear accessory drive). In some embodiments, the motor-generator unit 717 may be coupled to a flywheel of the engine. In other embodiments, the motor-generator unit may be disposed between the transmission and a differential for the vehicle powertrain. In still further embodiments, the motor-generator unit may be or form part of an electrically drive axle or may be directly connected to a wheel of the vehicle. It should be understood that the number of motor-generator or generator units may also be different in various embodiments.

It should be noted that although the diagrams herein may show a specific order and composition of processes, it is understood that the order of these processes may differ from what is depicted. For example, two or more processes may be performed concurrently or with partial concurrence. Also, some method processes that are performed as discrete processes may be combined, processes being performed as a combined step may be separated into discrete processes, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure.

The various concepts discussed herein may be implemented in any of numerous ways, as the described concepts are not limited to any particular manner of implementation. Examples of specific implementations and applications are provided for illustrative purposes.

Various numerical values herein are provided for reference purposes. Unless otherwise indicated, all numbers expressing quantities of properties, parameters, conditions, and so forth, used in the specification and claims are to be understood as being modified in all instances by the term “approximately.” Accordingly, unless indicated to the contrary, the numerical parameters set forth in the following specification and attached claims are approximations. Any numerical parameter should at least be construed in light of the number reported significant digits and by applying ordinary rounding techniques. The term “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. An electric auxiliary power distribution system for a hybrid electric vehicle, the electric auxiliary power distribution system comprising:
a battery pack;
a power system configured to supply power to the battery pack from an engine;
a charge determination module; and
a controller communicably coupled to the power system and the charge determination module, the controller configured to:
receive, from the charge determination module, a charge parameter associated with a hoteling event of the hybrid electric vehicle;
determine a threshold state of charge based on the charge parameter; and
control the power system to increase a state of charge of the battery pack to satisfy the threshold state of charge.

2. The electric auxiliary power distribution system of claim 1, wherein the charge determination module comprises a user interface configured to receive a user input indicative of a desired operating duration of a climate control system of the hybrid electric vehicle during hoteling, the controller configured to determine the threshold state of charge based on the user input.

3. The electric auxiliary power distribution system of claim 1, further comprising a location sensor configured to generate location data indicative of a geographic location of the hybrid electric vehicle, wherein the controller is further configured to:
determine, based on the location data, a charge duration; and
control the power system to increase a state of charge of the battery pack to satisfy the threshold state of charge within the charge duration.

4. The electric auxiliary power distribution system of claim 3, further comprising a battery sensor coupled to the battery pack, the battery sensor configured to generate charge data indicative of the state of charge of the battery pack, and wherein the controller is further configured to:
determine a charge rate based on the state of charge, the charge duration, and the threshold state of charge; and
control the power system to supply electrical energy to the battery pack according to the charge rate.

5. The electric auxiliary power distribution system of claim 3, wherein the controller is further configured to:
determine, based on the location data, a distance between the hybrid electric vehicle and a hoteling location; and
determine the charge duration based on the distance.

6. The electric auxiliary power distribution system of claim 1, wherein the charge determination module comprises a telematics module configured to communicably couple the controller to a fleet management service.

7. A hybrid electric vehicle comprising:
an engine system;
a cab coupled to the engine system;
a climate control system coupled to the cab; and
the electric auxiliary power distribution system of claim 1, wherein the charge parameter is indicative of an operating duration of the climate control system.

8. The hybrid electric vehicle of claim 7, further comprising:
a DC-to-DC converter coupled between the climate control system and the battery pack; and
a second battery coupled between the DC-to-DC converter and the engine system.

9. The electric auxiliary power distribution system of claim 1, wherein the charge parameter includes a hoteling condition that varies with duration of a hoteling event, and wherein the controller is configured to determine the threshold state of charge by at least one of averaging or integrating the hoteling condition over the duration.

10. The electric auxiliary power distribution system of claim 1, wherein the charge parameter includes a hoteling condition and a duration of the hoteling event, and wherein the controller is configured to determine the threshold state of charge by determining an energy usage associated with the hoteling condition and the duration.

11. The electric auxiliary power distribution system of claim 1, wherein the charge parameter includes at least one of a time period for hoteling, a location of hoteling, an environmental condition within a cab of the hybrid electric vehicle during hoteling, a weather condition, or a route condition.

12. The electric auxiliary power distribution system of claim 1, wherein the charge parameter includes at least one parameter indicative of an anticipated energy demand associated with the hoteling event and/or a post-hoteling vehicle operation.

13. The electric auxiliary power distribution system of claim 1, wherein the controller is configured to determine the threshold state of charge based on a combination of:
a hoteling condition that occurs during the hoteling event; and
a post-hoteling vehicle operating condition that occurs after the hoteling event.

14. The electric auxiliary power distribution system of claim 1, wherein the charge parameter is a learned parameter based on historical hoteling data.

15. An electric auxiliary power distribution system for a hybrid electric vehicle, comprising:
a battery pack;
a power system configured to supply power to the battery pack from an engine; and
a controller communicably coupled to the power system, the controller configured to:
determine a threshold state of charge for hoteling;
determine an estimated time period until a vehicle reaches a hoteling location based on a pre-hoteling condition;
determine a charge period based on the threshold state of charge; and
control the power system to prioritize charging of the battery pack when the estimated time period is within the charge period.

16. The electric auxiliary power distribution system of claim 15, wherein the controller is configured to prioritize charging of the battery pack by reducing torque assist below a torque assist threshold.

17. The electric auxiliary power distribution system of claim 15, wherein the controller is further configured to control the power system to prioritize transit operations when the estimated time period is outside of the charge period.

18. The electric auxiliary power distribution system of claim 17, wherein the controller is further configured to:
maintain the battery pack below a lower charge threshold when the estimated time period is outside of the charge period; and
charge the battery pack above the lower charge threshold when the estimated time period is within the charge period.

19. The electric auxiliary power distribution system of claim 15, wherein the controller is configured to maintain operation of the engine at a high efficiency operating condition during regenerative braking when the estimated time period is within the charge period.

20. The electric auxiliary power distribution system of claim 15, wherein the controller is further configured to iteratively update the estimated time period based on traffic conditions.

21. The electric auxiliary power distribution system of claim 15, wherein the controller is configured to prioritize charging of the battery pack by continuously increasing a state of charge of the battery pack as the vehicle approaches a hoteling location.

22. A method of charging a battery pack for a hybrid electric vehicle using an electric auxiliary power distribution system, the method comprising:
receiving, from a charge determination module of the electric auxiliary power distribution system, a charge parameter associated with a hoteling event of the hybrid electric vehicle;
determining, by a controller, a threshold state of charge based on the charge parameter; and
controlling, by the controller, a power system to increase a state of charge of the battery pack to satisfy the threshold state of charge.
